(19) United States
(12) Patent Application Publication
(10) Pub. No.: US 2007/0140269 A1
(43) Pub. Date: Jun. 21, 2007

(54) Cellular communication system on a work machine

(75) Inventors: Aaron M. Donnelli, Peoria, IL (US); Anthony D. McNealy, Peoria, IL (US); Alan L. Ferguson, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/311,308

(22) Filed: Dec. 20, 2005

(51) Int. Cl. H04L 12/56; H04L 12/26

(52) U.S. Cl. 370/401; 370/236

(57) ABSTRACT

A work machine communication system for providing cellular network communications on a work machine includes a work machine controller configured to control at least one operation of a work machine. The system may also include a gateway device including a Web server, the Web server being configured to provide bidirectional transfer of information to and from the work machine controller. The system may further include a cellular communication device configured to provide bidirectional transfer of the information between the gateway device and a cellular network.

### TECHNICAL FIELD

The present disclosure is directed to a system and method for cellular communications on a work machine, and, more particularly, to a system and method for cellular communication between a Web server on a work machine and entities located remotely from the work machine.

### BACKGROUND

Machines operating at a work site may have a need to communicate with other machines and devices that may be located remotely from the machine. This may be due to various reasons. One reason being that machines operating at a work site or related work sites may want to communicate operational information, such as, for example, position information, machine operational status, operating instructions, software data, location-related data (e.g., climatic conditions, local regulations, etc.), to each other. In addition, machines may need to communicate with remote devices, such as, for example, stationary devices (e.g., PCs, servers, etc.) and mobile devices (e.g., laptops, handheld devices, etc.), to exchange similar information.

Due to the number of machines operating at work sites and also due to the large distances that may exist between machines and remote devices, it may not be feasible to connect each machine to the other and/or to the remote devices by using a separate physical connection between each machine and a remote device. Thus, it may be desirable to connect the machines and remote devices to each other using a communication network. Furthermore, in some instances, the users and manufacturers of machines operating at a work site may not own a communication network of their own. In such instances, there may exist a need to leverage a third-party communication network, i.e., a communication network owned and operated by an entity other than the user and manufacturer of the machines and remote devices.

Different types of communication networks may be used to connect machines to remote devices. For example, satellite networks may be used to provide for communications between machines and remote devices. However, satellite networks have several shortcomings. These shortcomings may include, for example, high bandwidth costs, the need to obtain separate satellite licenses for every region in which satellite communication is desired, low data rates, etc. Thus, there exists a need to provide for a widely accessible and relatively cheap form of wireless communication between machines and also between machines and remote devices. One such form of wireless communication is cellular communications.

Thus, there exists a need for systems and methods that involve the use of cellular networks to facilitate communications between a machine and one or more remote devices. One related system and method is described in U.S. Pat. No. 6,739,078 to Morley et al. (“the '078 patent”), which issued on May 25, 2004. The '078 patent discloses a system to control a machine from a remote location using a cellular network that connects the machine to a user PC. Specifically, the system of the '078 patent discloses a system where a user PC sends instructions provided by a user over a cellular network to a remote PC that interfaces with the cellular network. The remote PC, in turn, transmits these instructions to a programmable controller on a machine. The programmable controller controls the machine in accordance with the instructions received from the remote PC.

While the system of the '078 patent provides for cellular communication between a machine and a remote device, it has several shortcomings. For example, while the system of the '078 patent allows for a user PC to send instructions to the machine, the system of the '078 patent does not appear to provide for the ability of the machine to send information to a remote device, such as, for example, a remote monitoring device or a remote computing device. Thus, the system of the '078 patent does not provide for bidirectional transfer of data between a machine and a remote device over a cellular network.

In addition, the system of the '078 patent does not appear to include a server on the machine that may permit one or more devices to view information, such as, for example, operational status information, component status information, etc., that may be stored in the machine. The lack of a server on the machine may also prevent the machine from simultaneously exchanging information, such as, for example, software information and location-related information, with multiple remote devices.

The present disclosure is directed to overcoming one or more of the problems of the prior art machine control system.

### SUMMARY OF THE INVENTION

In an exemplary embodiment, a work machine communication system for providing cellular network communications on a work machine includes a work machine controller configured to control at least one operation of a work machine. The system may also include a gateway device including a Web server, the Web server being configured to provide bidirectional transfer of information to and from the work machine controller. The system may further include a cellular communication device configured to provide bidirectional transfer of the information between the gateway device and a cellular network.

In another exemplary embodiment, a method for providing cellular network communications on a work machine comprises connecting a work machine controller to a gateway device including a Web server, wherein the Web server is configured to provide bidirectional transfer of information to and from the work machine controller. The method may also include connecting a cellular communication device to the gateway device, wherein the cellular communication device is configured to provide bidirectional transfer of the information between the gateway device and a cellular network.

Yet another exemplary embodiment includes a work machine. The work machine may include a frame and a power source operably connected to the frame. The work machine may also include a work machine controller configured to control at least one operation of the work machine. The work machine may also include a gateway device including a Web server, the Web server being configured to provide bidirectional transfer of information to and from the work machine controller. The work machine may also include a cellular communication device configured to provide bidirectional transfer of the information between the gateway device and a cellular network.

### BRIEF DESCRIPTION OF THE DRAWINGS

FIG. 1 is a pictorial representation of a work machine according to an exemplary disclosed embodiment.

FIG. 2 is a block diagram representation of a work machine communication system according to an exemplary disclosed embodiment.

FIG. 3 is a block diagram representation of a work machine control system according to an alternative exemplary disclosed embodiment.

### DETAILED DESCRIPTION

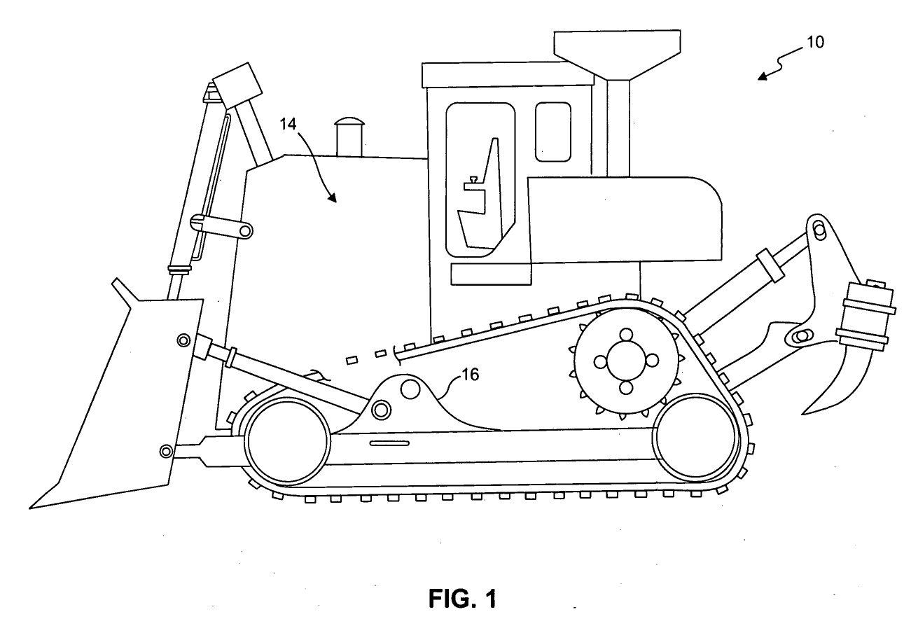

FIG. 1 provides a pictorial illustration of work machine 10. While work machine 10 is shown as a track type tractor, work machine 10 may include various other types of machines, such as, for example, an on-highway truck, an off-highway truck, an automobile, a dump truck, a stationary generator, or any other such device that includes one or more machine components configured to respond to input commands from an operator.

Work machine 10 may include a power source 14 and frame 16. Power source 14 may include one or more devices configured to provide power for the operation of work machine 10. These devices may include, for example, an electric motor, an engine, a battery, etc. In an exemplary embodiment, power source 14 may include an engine, such as, for example, a diesel engine, a gasoline engine, a steam engine, etc. In addition, any other engine configurable to provide power for the operation of work machine 10 may be used as power source 14. Power source 14 may be operatively coupled to frame 16.

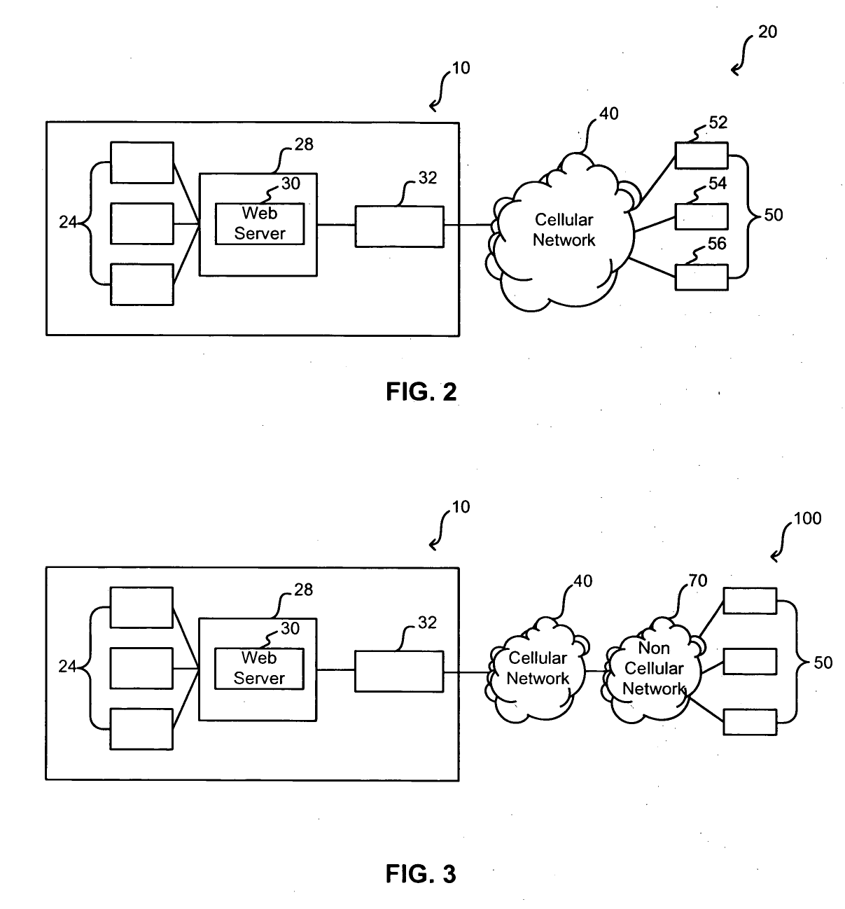

FIG. 2 is a block diagram representation of work machine communication system 20 for work machine 10. Work machine 10 may include one or more work machine controllers 24, a gateway device 28 that includes a Web server 30, and a cellular communication device 32. System 20 may also include a cellular network 40 and one or more remote entities 50. Remote entities 50 may include another work machine 52, a portable cellular device 54, and a computing device 56. Remote entities 50 may be located at the same work site as that of work machine 10. Alternatively, remote entities 50 may be located away from the work site of work machine 10, such as, for example, a different county, city, state, or country from that of work machine 10. Work machine controllers 24 may be configured to control one or more operations of work machine 10. These operations may include, for example, regeneration of exhaust elements, transmission control, payload control, hydraulic brake control, etc. In order to perform these operations, work machine controllers 24 may require information from one or more remote entities 50. This information may be related to one or more control settings on work machine controllers 24, such as regeneration duration, maximum allowable payload, etc. In addition, or alternatively, the information may also include software information for work machine controllers 24, such as, for example, a new program file, a software update, etc.

Furthermore, one or more remote entities 50 may need to view information such as parameter data related to the operation of work machine 10. This data may include, for example, the latest regeneration duration of an exhaust element on work machine 10, fuel consumption on work machine 10, etc. Gateway device 28 may be configured to provide bidirectional transfer of information to and from work machine controller 24. Specifically, gateway device 28 may include Web server 30 that may be configured to provide this bidirectional transfer of information between work machine controller 24 and one or more remote entities 50. Gateway device 28 may connect to one or more remote entities 50 via cellular network 40. Furthermore, gateway device 28 may connect to cellular network 40 via cellular communication device 32. Specifically, cellular communication device 32 may be configured to provide bidirectional transfer of information between gateway device 28 and cellular network 40.

Cellular network 40 may include a telecommunication network used to provide cellular communication service. Specifically, cellular network 40 may include cell phone towers that are used to relay phone conversations and data messages from one cellular subscriber to another. In addition, cell phone towers may also be configured to relay clock information to cellular devices. Cell phone towers may obtain clock information from a satellite with the help of a satellite receiver located at the cell phone towers or a base station. Cellular network 40 may operate on 2G cellular standards, such as, for example, CDMA (Code Division Multiple Access), GSM (Global System for Mobile Communications), and TDMA (Time Division Multiple Access). Alternatively, or in addition, cellular network 40 may also operate on 2.5G and/or 3G standards, such as, for example, GPRS (General Packet Radio Service) and WCDM (Wideband Code Division Multiple Access). In addition, cellular network 40 may operate on any other cellular standard configurable to permit the transmission of information from cellular network 40 to cellular communication device 32 and remote entities 50. Cellular network 40 may be operated by one or any combination of cellular network providers.

Remote entities 50 may include one or more remote devices that may connect to cellular network 40. As displayed in FIG. 2, remote entities 50 may include another work machine 52, a portable cellular device 54, and a computing device 56. Like work machine 10, work machine 52 may also connect to cellular network 40 in order to communicate with entities that are located remotely from work machine 52. To this end, work machine 52 may include one or more communication components (not shown) that may connect work machine 52 to cellular network 40. These communication components may include, for example, a cellular radio that is configurable to operate on work machine 52 and exchange data between work machine 52 and work machine 10 across cellular network 40.

Portable cellular device 54 may include a mobile communication device that may connect to cellular network 40. This device may include, for example, a cellular phone, a smart phone, a PDA, a Blackberry, a laptop, or any other mobile communication device configurable to transmit and receive data over cellular network 40. In an exemplary embodiment, these devices may include communication components, such as, a cellular transceiver, configurable to transmit and receive data over cellular network 40. Computing device 56 may include devices such as PCs, servers, and other such devices that are configurable to transmit and receive data over cellular network 40. In an exemplary embodiment, computing device 56 may connect to cellular network 40 through a wireless modem or any other cellular communication device with a connection to computing device 56.

One skilled in the art will appreciate that the remote entities 50 described above are exemplary only. In addition, any other entity capable of connecting to cellular network 40, directly or indirectly, and transmitting and receiving data over cellular network 40 may form part of remote entities 50.

Cellular communication device 32 may include one or more communication elements that may be used to provide connectivity between gateway device 28 and cellular network 40. These communication elements may include software components and hardware components configurable to exchange information between gateway device 28 and cellular network 40. The software components may include one or more program files written in any computing language such as C, C++, Pascal, etc. The hardware components may include a CPU, memory, I/O units, and any other component needed to operate a program file.

In an exemplary embodiment, cellular communication device 32 may include a cellular radio. The cellular radio may be configured to use high frequency radio waves to exchange data between cellular network 40 and gateway device 28. The cellular radio may include a transceiver (combination transmitter-receiver) that may provide a wireless connection between gateway device 28 and cellular network 40 and may be used to exchange data across cellular network 40. The type of transceiver used in the cellular radio may depend on the type of cellular network 40 that may be used to provide cellular connectivity in system 20. For example, if cellular network 40 is a GSM network, then the cellular radio may include a transceiver that may be compatible with parameters related to GSM technology such as the frequency spectrum and data rates at which a GSM network may operate. In an exemplary embodiment, a GSM-based cellular network 40 may operate at a data rate of 9.6 kbps. Thus, a transceiver on the cellular radio may be configured to exchange information at the rate of 9.6 kbps. Alternatively if cellular network 40 is a GPRS network, the transceiver on the cellular radio may be configured to operate at a data rate of 172.2 kbps (i.e., the theoretical maximum data rate at which a GPRS network may operate).

One skilled in the art will appreciate that while cellular communication device 32 has been described above as including a cellular radio, any other cellular device that may be configured to provide bidirectional transfer of information between cellular network 40 and gateway device 28 may be used as cellular communication device 32.

Cellular communication device 32 may operably connect to gateway device 28 using one or more connection means. These means may include wired connections, wireless connections, or any other means for connecting cellular communication device 32 to gateway device 28. Wired connections may include copper, optical fiber, or other such connections. Cellular device 32 may communicate with gateway device 28 using one or more communication protocols. These communication protocols may include datalink protocols and wireless protocols. Datalink protocols may include, for example, J1939, Ethernet, SAEJ1587, or other such protocols. Wireless protocols may include, for example, 802.11b, 802.11g, and other such protocols. Though FIG. 2 displays gateway device 28 and cellular communication device 32 as two separate units, in an alternative exemplary embodiment, gateway device 28 and cellular communication device 32 may be integrated into one physical unit.

Work machine controller 24 may represent one or more devices that may be configured to control the operations of work machine 10. In an exemplary embodiment, Work machine controller 24 may include devices, such as, for example, an engine controller module, a regeneration controller module, a transmission controller module, a hydraulics control module, or any other device capable of controlling at least one operation of work machine 10.

Work machine controller 24 may be configured to control various operations of work machine 10. For example, work machine controller 24 may be configured to control knocking in an engine. “Knocking” is uncontrolled fuel combustion detrimental to emissions, fuel economy, and engine longevity. Alternatively, work machine controller 24 may include a regeneration controller to control the “regeneration” of an exhaust element in an exhaust system of a work machine. Regeneration is the process of heating the particulate matter trapped in an exhaust element to a temperature at which the particulate matter combusts or vaporizes.

In yet another instance, work machine controller 24 may be configured to control the kind of braking system used in work machine 10. Specifically, work machine 10 may include multiple braking systems, such as, for example, a service brake system, an engine brake system, an exhaust braking system, and a transmission braking system. Depending on the need and the regulations specific to the work site, an operator may be authorized to use only some of the braking systems available on work machine 10. For example, environmental regulations prevalent at a work site may prevent the use of an engine brake in a work machine. Work machine controller 24 may therefore be configured to control the type of braking system that may be used on work machine 10 depending on the location of work machine 10. In addition, work machine controller 24 may be configured to control other such operations of work machine 10.

Work machine controller 24 may include components suitable for carrying out various operations for work machine 10. These components may include, for example, a memory (not shown) and a CPU (not shown), I/O modules (not shown), and any other component needed to run a program file. Furthermore, work machine controller 24 may need data to perform its various functions. This data may include information, such as, for example, the regeneration duration for a particulate trap, the desired air-to-fuel ratio in the engine, the engine speed at which the engine in work machine 10 may operate, the type of braking system work machine 10 may use, etc. In an exemplary embodiment, a portion of the data may be stored in the memory of work machine controller 24. Work machine controller 24 may be configured to receive a portion of the data it uses to control the operation of work machine 10 from one or more remote entities 50 via gateway device 28.

Work machine controller 24 may also be configured to provide information pertaining to one or more operations of work machine 10 to one or more remote entities 50 via gateway device 28. This information may include, for example, parameter reports related to the operation of work machine 10. These operations may include, for example, the fuel consumption of work machine 10, the vibrations measured at a location of work machine 10, the regeneration of an exhaust element of work machine 10, etc. In addition, work machine controller 24 may be configured to provide information related to any other operation of work machine 10.

Gateway device 28 may, among other things, be configured to provide bidirectional transfer of information between work machine controller 24 and one or more remote entities 50. This information, as described above, may include any information related to the operation of work machine 10. Gateway device 28 may be configured to provide for this bidirectional transfer of information by transmitting and receiving information over cellular network 40. Specifically, gateway device 28 may include Web server 30 that may be configured to exchange this information with one or more remote entities 50 via cellular network 40. In order to exchange this information, gateway device 28 may operably connect to work machine controller 24 and cellular communication device 32 that may operably connect to cellular network 40. In an exemplary embodiment, gateway device 28 may include programmable logic devices, such as, for example, PL300, PL1000e, and other electronic control devices configurable to include a Web server and transfer data from one communication port to another.

Web server 30 may be configured to provide bidirectional transfer of information to and from work machine controller 24. The bidirectional transfer of information may include information transferred from Web server 30 to one or more remote entities 50. This information transfer may occur in response to a request of information from one or more remote entities 50 to Web server 30. Web server 30 may be configured to retrieve the information requested from a database (not shown), or any other system that stores information related to work machine controllers 24. In an exemplary embodiment, one or more remote entities 50 may request this information via cellular network 40. Specifically, one or more remote entities 50 may connect to Web server 30 via cellular network 40 and cellular communication device 32, to view information related to the operation of work machine 10. In addition, one or more remote entities 50 may also download information related to the operation of work machine 10 via Web server 30.

The bidirectional transfer of information may also include the transfer of information from one or more remote entities 50 to Web server 30 via cellular network 40. This information may include information related to the operation of work machine 10, such as, for example, software information for work machine controllers 24. In addition, Web server 30 may receive any other information related to the operation of work machine 10 from one or more remote entities 50. Specifically, one or more remote entities 50 may connect to Web server 30 via cellular network 40 and cellular communication device 32, to upload such information to Web server 30. Web server 30 may be further configured to transfer the information received from remote entities 50 to devices on-board work machine 10, such as, work machine controllers 24. In addition, Web server 30 may be configured to transfer the received information to other on-board devices such as a display device (not shown).

In an exemplary embodiment, gateway device 28 may include different types of communication ports, such as, for example, serial ports, datalink ports, and Ethernet ports. Devices such as, for example, work machine controllers 24 and cellular communication device 32, may connect to communication ports on gateway device 28. Gateway device 28 may be configured to transfer information from one communication port to another. As described above, this information may include, for example, information related to the operation of work machine 10. Specifically, gateway device 28 may transfer this information between a communication port connected to a work machine controller 24 and a communication port connected to cellular communication device 32. Gateway device 28 may be configured to use a software application to perform functions, such as, for example, transferring information between cellular communication device 32 and work machine controller 24, translating information being transferred from one communication port to another, etc. Furthermore, the software application in gateway device 28 may also be used to operate Web server 30 that is included in gateway device 28. This software application may be written in a computing language, such as, for example, C, C++, Pascal, Visual C++, Visual Basic, etc. Furthermore, gateway device 28 may include a CPU, RAM, ROM, I/O modules, and any other component needed to run the software application.

In an exemplary embodiment, gateway device 28 may be configured to connect to cellular communication device 32 using an Ethernet port. This Ethernet port may be configured to operate using, for example, a wireless communication protocol, such as, for example, 802.11b. Alternatively, any other known method of connecting a cellular device to a gateway device may be used to connect cellular communication device 32 to gateway device 28. In addition, gateway device 28 may connect to a work machine controller 24 on a datalink port. Gateway device 28 may communicate on the datalink port using a datalink protocol, such as, for example, J1939. In order to transfer data between cellular communication device 32 and a work machine controller 24, gateway device 28 may be configured to translate information being transferred from the Ethernet port to the datalink port. In other words, gateway device 28 may translate data from 802.11b protocol to J1939 and vice versa. This translation may be performed by the software application stored in a memory unit of gateway device 28.

In an exemplary embodiment, one or more remote entities 50 may upload information, such as software code, via cellular network 40 to Web server 30 that is included in gateway device. Gateway device 28 may receive this information via cellular communication device 32 that is connected to cellular network 40. This information, that is received at the Ethernet port of gateway device 28, may be stored in a memory unit associated with gateway device 28. The CPU of gateway device 28 may determine the port of exit for this received data. For example, the CPU of gateway device 28 may determine that this received data is destined to exit gateway device 28 through the datalink port connected to a work machine controller 24. Therefore, the CPU may translate the information from 802.11b to J1939 and transfer this information to the datalink port connected to work machine controller 24. As mentioned above, the software application running in gateway device 28 may perform the function of translating the information from one protocol to another. One skilled in the art will appreciate that a similar process of information translation of data from J1939 to 802.11b may be performed by gateway device 28 to transfer data from work machine controller 24 via Web server 30 to one or more remote entities 50.

While the embodiment discussed above describes gateway device 28 being connected to work machine controllers 24 and cellular communication device 32, one skilled in the art will appreciate that gateway device 28 may connect to other devices and systems besides work machine controller 24 and cellular communication device 32. For example, in an exemplary embodiment, gateway device 28 may connect to a display device (not shown) and an input device (not shown) on work machine 10. The display device may be any known type of device that presents information to an operator on work machine 10. Thus, gateway device 28 may, among other functions, display information received from work machine controller 24, remote entities 50, and other such devices/systems to the display device. For example, Web server 30 may display information obtained from work machine controller 24, remote entities 50, or information obtained from any other source, on the display device connected to gateway device 28. The input device may include any device that may be used to transfer information from the operator to gateway device 28, such as, for example, a keyboard, mouse, etc.

In an exemplary embodiment, gateway device 28 may be configured to provide voice communications for a user on work machine 10. Specifically, a communication port on gateway device 28, such as, for example, a USB port, a serial port, etc., may be configured to connect to one or more voice communication devices (not shown). These voice communication devices may include devices, such as a mike, intercom, speakers, etc. A user on work machine 10 may use the combination of the voice communication devices and cellular communication device 32 on work machine 10 to have voice communications with one or more remote entities 50 across cellular network 40.

Furthermore, gateway device 28 may also connect to a diagnostic device, such as, for example, a PC or laptop, that may be configured to monitor and configure gateway device 28. In an exemplary embodiment, gateway device 28 may use a datalink port, such as, for example, a J1939 port, to connect to a diagnostic device. In addition, other ports, such as a wireless port, optical fiber port, Ethernet port, serial port, etc., may be used to connect gateway device 28 to a diagnostic device.

Web server 30 may be configured to permit one or more remote entities 50 to view information stored on work machine 10. This information may include information related to the operation of work machine 10. Information related to the operation of work machine 10 may include, for example, control settings related to the operation of work machine controllers 24, parameter reports, etc. If a work machine controller 24 operates as a regeneration controller, the control settings may include, for example, the regeneration duration set on work machine controller 24. Parameter reports may include information such as, for example, the fuel consumption of work machine 10, the vibrations measured at one or more locations on work machine 10, etc. In addition, Web server 30 may be configured to display any other information that may be stored on work machine 10 to any entity capable of viewing that information.

Web server 30 may also be configured to facilitate the upload and/or download of information to and from work machine 10. Specifically, Web server 30 may be configured to transfer information from work machine controllers 24 to one or more remote entities 50 via cellular communication device 32 and cellular network 40. This information may include information related to the operation of work machine 10. This operational information may include, for example, position information, log messages, machine component information, etc. In addition, Web server 30 may be configured to facilitate the transfer of any other information transferable from work machine 10 to remote entities 50. Web server 30 may also be configured to facilitate the transfer of information from one or more remote entities 50 to work machine 10. Remote entities 50 may be configured to transfer this information via cellular network 40 to Web server 30. This information may include, for example, software information related to the operation of work machine 10. This software information may include, for example, a new program file for a work machine controller 24, a software upgrade for the program file on a work machine controller 24, etc. In addition, remote entities 50 may be configured to transfer other information related to the operation of work machine 10 to Web server 30.

Web server 30 may include hardware components and software components that may be configured to facilitate the operation of Web server 30. The software components may include an operating system and a Web server application software. The Web server application software included on Web server 30 may depend on the operating system running on Web server 30. For example, if Web server 30 is operating on a Windows-based operating system, then Web server 30 may include software, such as, for example, Internet Information Server (“]]S”), Windows 2000 server, etc. Alternatively, if Web server 30 is operating on a UNIX-based operating system, then Web server 30 may include software, such as, for example, Apache HTTP server, Sun Java System Web server, Zeus Web server, etc. In addition, any other type of software capable of being configured as Web server application software may be used to facilitate the operation of Web server 30. Web server 30 may also include hardware components such as a CPU (not shown), memory (not shown), I/O modules (not shown), and any other component needed to run an operating system and Web server application software.

In an exemplary embodiment, all the functionalities of gateway device 28, such as, for example, transferring information from one communication port to another, translation of information from one communication protocol to another, functionalities of Web server 30, etc., may be performed on common hardware components. These hardware components, as described above, may include CPU, memory, I/O modules, etc. Alternatively, different functions of gateway device 28 may be performed on hardware components specifically reserved for those functions. For example, all the functions of Web server 30, such as obtaining information requests from one or more remote entities 50, providing information in response to these requests, etc., may be performed on hardware components specifically reserved for functions to be performed by Web server 30. Similarly, other functions of gateway device 28 (information transfer, information translation, etc.) may be performed on separate hardware components specifically reserved for those functions. In an exemplary embodiment, all the components of gateway device 28 may be integrated into one physical unit to perform the operations noted above. Alternatively, gateway device 28 may include two or more separate units that may be configured to perform the above-mentioned operations.

Remote entities 50 may connect to Web server 30 on gateway device 28 via cellular network 40. Cellular network 40 may connect to gateway device 28 that includes Web server 30, via cellular communication device 32. Furthermore, gateway device 28 may connect to work machine controller 24. Upon the formation of a connection between Web server 30 and one or more remote entities 50 via cellular communication device 32 and cellular network 40, Web server 30 may provide bidirectional transfer of information between work machine controller 24 and the connected remote entities 50. Specifically, upon receipt of a request for information from one or more remote entities 50, Web server 30 may retrieve the information from work machine controller 24 and display the information to the requesting remote entity 50. Remote entities 50 may also download the requested information from Web server 30. In addition, or alternatively, remote entities 50 may send information (i.e., information upload) to Web server 30. Upon receipt of this information, Web server 30 may transfer the received information to work machine controller 24.

Remote entities 50 may include software that may be configured to let remote entities 50 interface with Web server 30. Interfacing with Web server 30 may include connecting to Web server 30 and transferring information to and from Web server 30. This interface software may include Web server compatible software such as, for example, web browsers. In addition, remote entities 50 may include any other software that may be configured to interface remote entities 50 with Web server 30 across cellular network 40. The interface software may be written in any computing language such as C, C++, Visual C++, Java, Pascal, etc. Furthermore, the interface software on remote entities 50 may be configured to use one or more communication protocols for bidirectional transfer of information to and from Web server 30. These communication protocols may include, for example, Hypertext Transfer Protocol (“HTTP”), Secure Hypertext Transfer Protocol (“HTTPS”), File Transfer Protocol (“FTP”), Trivial File Transfer Protocol (“TFTP”), Kermit, etc. In addition, the interface software on remote entities 50 may use other such communication protocols for communication with Web server 30.

Depending on the nature of information transfer (i.e., information upload to Web server 30 or information download from Web server 30) and the type of communication protocol being used by the remote entity 50, different types of connections may be formed between remote entity 50 and Web server 30. For example, portable cellular device 54 may include a web browser that may interface with Web server 30. Furthermore the web browser may be configured to use HTTP for information transfer between portable cellular device 54 and Web server 30. If portable cellular device 54 is uploading information (e.g., software information) to Web server 30, then portable cellular device 54 may use a HTTP “Put” connection to transfer the information via cellular network 40. Web server 30 may transfer the received information via a communication port of gateway device 28 to work machine controller 24. In addition, or alternatively, if portable cellular device 54 needs to obtain information from work machine controller 24, then portable cellular device 54 may generate a HTTP “get” request for Web server 30. The “get” request may include a request for the kind of information needed from work machine controller 24 by portable cellular device 54. Upon receipt of this request, Web server 30 may retrieve this information either from work machine controller 24 or from an information storage device, such as a database, that may retrieve and store such information from work machine controller 24. Web server 30 may then transfer the retrieved information to portable cellular device 54 via cellular network 40.

Web server 30 may be configured to provide simultaneous bidirectional transfer of information with a plurality of remote entities 50. In an exemplary embodiment, while portable cellular device 54 is exchanging information with Web server 30, another remote entity such as computing device 56 may also connect to Web server 30 via cellular network 40. Each connection from these remote entities to Web server 30 may be characterized by a unique identifier, such as, for example, a session id. Thus, Web server 30 may distinguish between the connections to portable cellular device 54 and computing device 56 based on each connection's unique session id. While portable cellular device 54 is exchanging information with Web server 30, computing device 56 may also exchange information with Web server 30. Similar to portable cellular device 54, computing device 56 may include interface software that may facilitate the exchange of information with Web server 30. In addition, other remote entities such as, for example, another work machine 52, may also simultaneously connect to Web server 30 via cellular network 40 such that Web server 30 may provide bidirectional transfer of information to the other remote entities. An operator of Web server 30 may limit the number of remote entities 50 that may stay connected to and exchange data with Web server 30.

FIG. 3 is a block diagram representation of an alternative work machine communication system 100. Communication system 100 is similar to communication system 20 displayed in FIG. 2, except that communication system 100 may include noncellular network 70. In some instances, one or more remote entities 50 may not have a direct connection to cellular network 40. In such an event, noncellular network 70 may be used to interconnect cellular network 40 to the remote entities 50 lacking a direct connection to cellular network 40. Noncellular network 70 may include a public switched telephone network, a private computer network, and the Internet. In addition, noncellular network 70 may include any other communication network that may be configured to connect with cellular network 40 and one or more remote entities 50.

A private computer network may include a number of interconnected computing devices that may be configured to provide access to only a limited number of end devices. The end devices in this limited group may include one or more remote entities 50. By providing access to only a limited number of end devices, the private computer network, unlike the Internet, may not provide public access to it. In addition, the private computer network may be configured to connect to cellular network 40. Thus, the private computer network may connect one or more remote entities 50 to cellular network 40. Remote entities 50 that may connect to the private computer network may therefore communicate with work machine 10 via the private computer network and cellular network 40. The computing devices in the private computer network may include routers, switches, hubs, repeaters, multiplexers, firewalls, and other such devices. The private computer network may use one or more routing protocols, such as, for example, Internet Protocol (“IP”), DECNET, X.25, etc., for the bidirectional transfer of data across the private computer network.

Communication system 100 may include one or more cellular interconnection devices (not shown) that may be configured to facilitate the connection of cellular network 40 to noncellular network 70. These cellular interconnection devices may further include one or more components that may be configured to interconnect cellular network 40 to noncellular network 70. The type of cellular interconnection device used in communication system 100 may depend, in part, on the type of cellular network 40 and the type of noncellular network 70 in communication system 100. For example, if cellular network 40 is a GPRS network, then cellular network 40 may include a Gateway GPRS Support Node (“GGSN”) (not shown) that may be configured to interconnect the GPRS network to noncellular network 70 such as the Internet or a private computer network. Specifically, the GGSN may be configured to convert the GPRS packets coming from a cellular device into the appropriate packet data protocol (PDP) format (e.g., IP, X.25, etc.) and send them out on the corresponding packet data network. In the other direction, the GGSN may be configured to convert PDP addresses of incoming data packets to the GSM address of the destination user. The readdressed packets may then be sent to the responsible cellular device. The cellular device in a GPRS network that may interface with a GGSN may include a Serving GPRS Support Node (“SGSN”) (not shown). A SGSN may be configured to track the location of mobile cellular devices and route data traffic obtained from the GGSN to the mobile cellular devices.

The GGSN and SGSN may include hardware and software components to interconnect cellular network 40 to noncellular network 70. The software may be written in any computing language, such as, for example, C, C++, Pascal, Java, Visual C++, etc. The hardware components may include a CPU, I/O modules, memory, and any other component needed to run a software program. In addition to a GGSN and SGSN, communication system 100 may include other types of cellular interconnection devices that may be configured to connect cellular network 40 to noncellular network 70.

### INDUSTRIAL APPLICABILITY

The disclosed embodiments may be used in any communication system in which data may be transferred between a work machine and entities located remotely from the work machine. These embodiments may provide improvements over the existing work machine communication systems and methods. For instance, the use of a cellular network for communication between work machines and entities located remotely from the work machine may eliminate the need for wired connections between work machines and these remote entities The use of a wireless connection between work machines and remote entities may overcome any topographical and distance constraints associated with wired connections in a communication system. Furthermore, the use of a cellular network as a means for communication may provide advantages over other wireless networks. For example, a cellular network may provide increased data rates and cheaper bandwidth than existing satellite networks.

Unlike prior art cellular communication systems, the disclosed embodiments may use a Web server to provide for communication between a work machine and entities located remotely from the work machine. The Web server may be used to provide bidirectional transfer of information between a work machine and these remote entities. Thus, unlike prior art communication systems, not only may a remote entity send information across a communication network to a work machine, but a work machine may also transfer information to a remote entity.

The use of a Web server on a work machine for bidirectional transfer of information may provide additional improvements over prior art systems. For example, a Web server on a work machine may permit multiple remote entities to simultaneously connect to the work machine and view information stored on the work machine. In addition, multiple remote entities may also simultaneously download data from the Web server so that the data may be stored locally on the remote entity. An operator of the Web server on the work machine may also restrict the number of remote entities that may simultaneously access the work machine by limiting the number of remote entities that may connect to the Web server at one time. Furthermore, an operator of the Web server on the work machine may also be able to use the logging capabilities of the Web server to log information pertaining to the connections made between the Web server on the work machine and entities located remotely from the work machine. This connection information may include information, such as, for example, the type and number of remote entities that have connected to the Web server, the type of information transferred between the Web server and the remote entities, the days and times of peak information transfer, etc. Such information may be useful to users of a work machine in analyzing data traffic flows to and from the work machine.

It will be apparent to those skilled in the art that various modifications and variations can be made in the disclosed cellular communication system and method without departing from the scope of the disclosure. Additionally, other embodiments of the disclosed system will be apparent to those skilled in the art from consideration of the specification. It is intended that the specification and the examples be considered exemplary only, with a true scope of the disclosure being indicated by the following claims and their equivalents.

What is claimed is:

1. A work machine communication system for providing cellular network communications on a work machine comprising:
a work machine controller configured to control at least one operation of a work machine;
a gateway device including a Web server, the Web server being configured to provide bidirectional transfer of information to and from the work machine controller; and
a cellular communication device configured to provide bidirectional transfer of the information between the gateway device and a cellular network.

2. The system of claim 1, wherein the gateway device is further configured to provide voice communications for a user of the work machine.

3. The system of claim 1, further including a remote entity operably connected to the cellular network, the remote entity being configured for bidirectional transfer of the information to and from the Web server via the cellular network.

4. The system of claim 3, wherein the remote entity is operably connected to the cellular network via a public switched telephone network.

5. The system of claim 3, wherein the remote entity is operably connected to the cellular network via a private computer network.

6. The system of claim 3, wherein the remote entity is operably connected to the cellular network via the Internet.

7. The system of claim 3, wherein the information includes information related to an operation of the work machine.

8. The system of claim 7, wherein the information related to an operation of the work machine includes software information for the work machine controller.

9. The system of claim 7, wherein the information includes information related to one or more control settings on the work machine controller.

10. The system of claim 7, wherein the information includes a parameter report related to the operation of a work machine.

11. The system of claim 10, wherein the parameter report includes information related to a fuel consumption of the work machine.

12. The system of claim 10, wherein the parameter report includes information related to one or more vibrations measured at a location on the work machine.

13. The system of claim 10, wherein the parameter report includes information related to regeneration of an exhaust element of the work machine.

14. A method for providing cellular network communications on a work machine, the method comprising:
connecting a work machine controller to a gateway device including a Web server, wherein the Web server is configured to provide bidirectional transfer of information to and from the work machine controller; and
connecting a cellular communication device to the gateway device, wherein the cellular communication device is configured to provide bidirectional transfer of the information between the gateway device and a cellular network.

15. The method of claim 14, further including configuring the gateway device to provide voice communications for a user on the work machine.

16. The method of claim 14, further including connecting a remote entity to the cellular network, the remote entity being configured for bidirectional transfer of the information to and from the Web server via the cellular network.

17. The method of claim 16, further including operably connecting the remote entity to the cellular network via at least one of a public switched telephone network, a private computer network, and the Internet.

18. The method of claim 16, wherein the information includes information related to an operation of the work machine.

19. The method of claim 16, wherein the information includes a parameter report related to an operation of a work machine.

20. A work machine including:
a frame;
a power source operably connected to the frame;
a work machine controller configured to control at least one operation of a work machine;
a gateway device including a Web server, the Web server being configured to provide bidirectional transfer of information to and from the work machine controller; and
a cellular communication device configured to provide bidirectional transfer of the information between the gateway device and a cellular network.

21. The work machine of claim 20, wherein the gateway device is further configured to provide voice communications for a user of the work machine.

22. The work machine of claim 20, wherein the information includes information related to the operation of the work machine.

23. The work machine of claim 20, wherein the information includes a parameter report related to the operation of a work machine.
